(19) United States
(12) Patent Application Publication
(10) Pub. No.: US 2007/0290563 A1
(43) Pub. Date: Dec. 20, 2007

(54) BRUSHLESS MOTOR WITH DOUBLE ROTORS

(75) Inventors: Hang ZHAO, Tianjin (CN); Guangkui Shi, Tianjin (CN); Wei Li, Tianjin (CN); Renjun Wan, Tianjin (CN); Qi Feng, Tianjin (CN)

Correspondence Address: LEONG C LEI, PMB # 1008, 1867 YGNACIO VALLEY ROAD, WALNUT CREEK, CA, 94598, US

(73) Assignee: CHINA AUTOMOTIVE TECHNOLOGY & RESEARCH CENTER, Tianjin (CN)

(21) Appl. No.: 11/564,856

(22) Filed: Nov. 30, 2006

(30) Foreign Application Priority Data
Jun. 14, 2006 (CN) 200610014350.9

(51) Int. Cl. H02K 16/02; H02K 1/22

(52) U.S. Cl. 310/114; 310/266

(57) ABSTRACT

It is a type of brushless motor with double rotors which is composed of one inside motor with radial-vertical permanent magnetic circuit and one outside motor with magnetic excitation circuit. The inside motor is made up of the input shaft, the inner rotor core, the permanent magnetic steel of the inner rotor, the external rotor core and the inner winding of the external rotor. The outside motor is made up of the stator winding, the stator core, the external rotor core and the external winding of the external rotor. From the inside toward outside, the specific structural arrangement is as follows: the input shaft, the inner rotor, the inner rotor core, the permanent magnetic steel of inner rotor core, the external rotor core, the inner winding of external core, the external winding of external rotor, the stator core, the stator winding and the shell. The inner rotor core is fixed on the input shaft and spin together with the shaft; the stator core is fixed on the shell, and the external rotor core is rigidly connected with the output shaft and spin together with the shaft. The inner winding of the external rotor and the external winding of external rotor are mutually connected to form a circuit. The motor may coordinate the work between the inner and external motors only through a set of inverter. This invention is low in cost, compact in structure, reliable in function, and long in service life.

### BACKGROUND OF THE INVENTION

(a) Technical Field of the Invention

This invention is concerned with a type of electrical rotator, particularly a type of brushless motor with double rotors.

(b) Description of the Prior Art

The hybrid power driving system includes the following three types: the series connection, parallel connection, and series-parallel connection. The principle of the series connection hybrid power system is that first transforming all output power from the engine into the electric energy through a generator, and then through the motor, transforming the electric energy into the mechanical energy to drive the wheel. The strongpoint of such a system is that is may optimize the control over the engine; while the shortcoming lies in that twice total conversion of energy leads to too much energy losses. The principle of the parallel connection system is adding another electrical driving system to the traditional auto transmission system so as to provide assisting driving force when the vehicle accelerates or runs uphill. Its strongpoint is that the percentage for energy conversion is small, and the shortcoming is that the engine and the wheel are directly and mechanically connected, and the engine could not always work at the high efficient point. The common series-parallel connection is to divide the engine power into the mechanical route and the electric power route through special power distribution device. It could make use of the strongpoint of both the series connection and the parallel connection. However, it is complex in structure and high in cost, and meanwhile the complicated transmission structure may lower the transmission efficiency.

### SUMMARY OF THE INVENTION

The primary purpose of the present invention is to overcome the existing technical faults as mentioned above, and provide a kind of brushless motor with double rotors. Such motor is composed of one inside motor with radial permanent magnetic circuit and one outside motor with magnetic excitation circuit. Its input shaft is connected with the crank shaft of the engine, and the output shaft is connected with the driven bridge. It may coordinate the work of the inside motor and outside motor through a set of inverter, making the engine operating at the high efficient point, thus enhancing the efficiency of the whole system. In addition, it is low in cost, light in weight and compact in structure. Meanwhile, since there is neither carbon brush nor slip ring, the motor also has the strongpoint of simple structure, reliable performance, and long service life. In order to solve above-mentioned technical problems, the technical plan adopted in this invention is as follows: It adopts a type of brushless motor with double rotors which is composed of one inside motor with radial-vertical permanent magnetic circuit and one outside motor with magnetic excitation circuit. The inside motor is made up of the input shaft, the inner rotor core, the permanent magnetic steel of inner rotor, the external rotor core and the inner winding of external rotor. The outside motor is made up of the stator winding, the stator core, the external rotor core and the external winding of external rotor. From the inside toward outside, the specific structural arrangement is as follows: the input shaft, the inner rotor, the inner rotor core, the permanent magnetic steel of inner rotor core, the external rotor core, the inner winding of external core, the external winding of external rotor, the stator core, the stator winding, and the shell. The inner rotor core is fixed on the input shaft and spin together with the shaft; the stator core is fixed on the shell, and the internal and external rotor core is rigidly connected with the output shaft and spin together with the shaft. And the inner winding of external rotor and the external winding of external rotor are mutually connected, thus forming a circuit, and the stator winding is connected with the inverter.

The above-mentioned permanent magnetic steel of the inner rotor is situated on the surface of the inner rotor core, forming the surface-type inner rotor structure with magnetic steel.

The above-mentioned permanent magnetic steel of the inner rotor is embedded in the inner rotor core, forming the interior-type inner rotor structure with magnetic steel.

The favorable results of this invention are as follows: 1. In this system, without using any carbon brush nor slip ring, the motor is small in size, compact in structure, low in cost, reliable in performance, and long in service life. In this system, a set of inverter is enough to coordinate the work of the inside motor and outside motor. The motor system is low in cost, light in weight and compact in structure. 2. Since there is not direct mechanical connection between the engine and the wheel, the engine can be adjusted to work at high efficient point. When the load changes, it is only necessary to adjust the magnetic torque generated by the stator magnetic field, thus the engine may operate with maximum efficiency under most working conditions and bears no relationship with any changes of the load. Consequently, such hybrid power speed control driven system consumes less fuel, discharges less wastes, and is highly efficient and environmental-friendly. 3. When the vehicles lower the speed, the magnetic power of the inside motor may be removed, while the outside motor may regenerate sufficient braking energy, thus improving energy utilizing efficiency and saving energy. 4. Driving speed of the automobile and speed of the engine are mutually independent, and the motor may realize the stepless speed transmission from the engine to the wheel. 5. In this system, some mechanical transmission devices are omitted, and there is no need to install the clutch. Use of small speed change or no speed change box brings less energy transformation, reduces the transmission links and improves the transmission efficiency; and it uses less space parts, and is simple in structure and low in cost.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is the side view of the surface-type brushless double-rotor motor structure with magnetic steel

FIG. 2 is the section view of the surface-type brushless double-rotor motor structure with magnetic steel

### EXPLANATION TO THE DRAWING MARKS OF MAJOR SPARE PARTS

1. Input shaft; 2. Inner rotor core; 3. Permanent magnetic steel of inner rotor; 4. Inner winding of external rotor; 5. External winding of external rotor; 6. External rotor core; 7. Stator core; 8. Stator winding; 9. Output shaft; 10. Shell; 11. Inverter.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

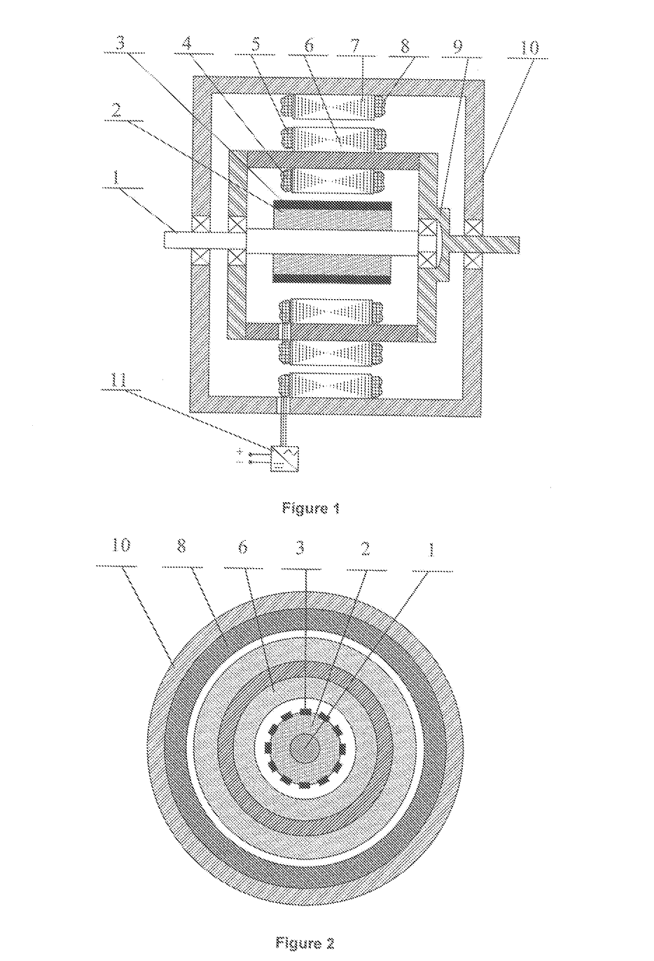

As shown in FIGS. 1 and 2, such brushless permanent magnetic motor with double rotors is featured by one inside motor with radial-vertical permanent magnetic circuit and one outside motor with magnetic excitation circuit. The inside motor is made up of the input shaft 1, inner rotor core 2, permanent magnetic steel of inner rotor 3, external rotor core 6 and inner winding of external rotor 4. The outside motor is made up of the stator winding 8, stator core 7, external rotor core 6 and external winding of external rotor 5. From the inside toward outside, the specific structural arrangement is as follows: the input shaft 1, the inner rotor core 2, the permanent magnetic steel of inner rotor core 3, inner winding of external core 6, and external winding of external rotor 4, stator core 7, stator winding 8, and the shell 10. The inner rotor core 2 is fixed on the input shaft 1 and spin together with the shaft, the stator core 7 is fixed on the shell 10, and the external rotor core 6 is rigidly connected with the output shaft 9 and spin together with the shaft. Among them, the inner winding of external rotor 4 and the external winding of external rotor 5 are mutually connected and form a closed circuit, and the stator winding 8 is connected with the inverter 11.

The input shaft 1 is connected with the engine's crankshaft. The surface of the inner rotor is installed with the permanent magnetic steel and the inner rotor is fixed on the input shaft 1 for passing the power and energy from the engine. The external rotor has two one set of inside armature winding and one set of outside armature winding, and it is mechanically connected with the output shaft 9. The output shaft is connected with the load to output the power and energy. From above-mentioned motor structure with double-rotor, we may see that the brushless hybrid magnetic excitation motor with double rotors in an integration of two motors, one is composed of the external rotor and the stator, and another is composed of the external rotor and the inner rotor.

The permanent magnetic steel in the inner rotor structure can be fixed on the surface of the inner rotor or inserted inside the rotor.

According to different position for fixing the permanent magnetic steel, the inner rotor can be classified into the surface-type inner rotor structure and the interior-type inner rotor structure. If the permanent magnetic steel is fixed on the surface of the inner rotor, it is the surface-type inner rotor structure; it is featured as the motor having relatively big effective air gap, the armature response being greatly reduced, and simple structure. If the permanent magnetic steel is inserted inside the rotor, it is the interior-type inner rotor structure; it is featured as high magnetism which may generate extra reluctance component and being helpful for the running status with constant power; by inserting the permanent magnetic steel into the rotor, the mechanical completeness during high-speed running may be maintained.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. The characteristics of such brushless motor with double rotors lies in that it is composed of one inside motor with radial-vertical permanent magnetic circuit and one outside motor with magnetic excitation circuit. The inside motor is made up of the input shaft (1), the inner rotor core (2), the permanent magnetic steel of inner rotor (3), the external rotor core (6) and the inner winding of external rotor (4). The outside motor is made up of the stator winding (8), the stator core (7), the external rotor core (6) and the external winding of external rotor (5). From the inside toward outside, the specific structural arrangement is as follows: the input shaft (1), the inner rotor core (2), the permanent magnetic steel of inner rotor core (3), the external rotor core (6), the inner winding of external rotor (4), the external winding of external rotor (5), the stator core (7), the stator winding (8) and the shell (10). The inner rotor core (2) is fixed on the input shaft (1) and spin together with the shaft, the stator core (7) is fixed on the shell (10), and the external rotor core (6) is rigidly connected with the output shaft (9) and spin together with the shaft. The inner winding of the external rotor (4) and the external winding of the external rotor (5) share a mutual connection and thus form a circuit, and the stator winding (8) is connected with the inverter (11).

2. The feature of the brushless motor with double rotors as described in Rights 1 is that the above-mentioned permanent magnetic steel of the inner rotor (3) is situated on the surface of the inner rotor core (2), forming the surface-type inner rotor structure with magnetic steel. 3. The feature of the brushless motor with double rotors as described in Rights 1 is that the above-mentioned permanent magnetic steel of the inner rotor (3) is embedded in the inner rotor core (2), forming the interior-type inner rotor structure with magnetic steel. 4. The feature of the brushless motor with double rotors as described in Rights 1 is that it only needs a set of inverter to coordinate the work between the inside motor and outside motor.
